(19) United States
(12) Patent Application Publication
(10) Pub. No.: US 2022/0395925 A1
(43) Pub. Date: Dec. 15, 2022

(54) METHOD FOR LASER MACHINING A WORKPIECE AND ASSOCIATED LASER MACHINING SYSTEM

(71) Applicant: Precitec GmbH & Co. KG, Gaggenau (DE)

(72) Inventors: Tom Walde, Offenburg (DE); Rüdiger Moser, Malsch (DE); Maurizio Kempf, Völkersweiler (DE); Christoph Kehret, Rheinau (DE)

(21) Appl. No.: 17/837,410

(22) Filed: Jun. 10, 2022

(30) Foreign Application Priority Data
Jun. 10, 2021 (DE) 102021115036.1

(51) Int. Cl. B23K 26/06; B23K 26/073; B23K 26/082

(52) U.S. Cl. CPC B23K 26/0626; B23K 26/0734; B23K 26/0613; B23K 26/082; B23K 26/21

(57) ABSTRACT

A method of laser machining a workpiece includes the steps of: radiating a laser beam onto at least one workpiece, the laser beam having a core beam and a ring beam extending coaxially with one another, wherein the laser beam is moved over the workpiece along a pre-determined machining path, and adjusting a laser power of the core beam and/or a laser power of the ring beam as a function of a position of the laser beam on the workpiece. An associated laser machining system is also disclosed.

### CROSS-REFERENCE TO RELATED APPLICATION

This application claims priority to German Patent Application No. 10 2021 115 036.1, filed on Jun. 10, 2021, which is hereby incorporated by reference in its entirety.

### FIELD OF THE INVENTION

The present disclosure relates to a method for laser machining work pieces, and a laser machining system for laser machining work pieces.

### BACKGROUND OF THE INVENTION

In a laser machining system, also referred to as a laser machining plant or plant, the laser beam emerging from a laser beam source or one end of a laser optical fiber is radiated and focused onto the workpieces with the aid of beam guiding and focusing optics for machining workpieces. The laser machining system may include a laser machining head in which the beam guiding and focusing optics is integrated. Usually, the laser beam is moved over the surface of the workpieces along a machining path. When the laser beam is radiated, the material of the workpieces heats up so much due to the incident laser power that it melts and evaporates. Machining may include joining or separating workpieces, for example laser cutting or laser welding.

When machining, in particular when laser welding, materials such as aluminum or aluminum alloys, in particular alloys of the 6 and 7 series, or high-strength steels, so-called hot cracks increasingly occur. In addition, the increased formation of spatter during laser welding may pose a problem, particularly occurring with copper and copper alloys. Both problems may also occur in combination, especially when different materials are joined. Above all, the problems arise when welding workpieces made of materials with very different thermal conductivities, for example when aluminum and copper are welded together. Various approaches have been developed to prevent these problems.

WO 2018/011456 A1 describes the use of laser beams with a core beam and a ring beam for laser material machining extending concentrically thereto.

Laser welding of workpieces may be carried out by superimposing the movement of the laser beam along the machining path with “wobbling”, which may increase the quality of the resulting weld seam.

The solutions mentioned lead to an alleviation of the problem, but cannot completely eliminate it, particularly in the case of high machining speeds and demanding material combinations.

### SUMMARY OF THE INVENTION

It is an object of the present disclosure to provide a method for laser machining for preventing machining defects, particularly hot cracks and spatters, and increasing machining quality. In particular, it is an object of the present invention to provide a method for laser machining with which the machining quality can be increased when machining workpieces with different thermal conductivities.

A further object of the invention is to enable laser machining, in particular laser welding, with consistent machining quality at higher speeds and for more demanding material combinations.

It is a further object of the present disclosure to provide a laser machining system configured to carry out the method.

The objects are achieved by the subject matter disclosed herein. Advantageous refinements and developments are the subject matter are also disclosed.

According to a first aspect of the present disclosure, a method for laser machining a workpiece is provided. The method comprises the steps of: radiating a laser beam onto at least one workpiece, the laser beam comprising a core beam and a ring beam which extend coaxially to one another, wherein the laser beam is guided or moved over the workpiece along a predetermined machining path, and adjusting or modulating a laser power of the core beam and/or a laser power of the ring beam dependent on or as a function of a (current) position of the laser beam on the workpiece.

According to a second aspect of the present disclosure, a laser machining system configured to carry out the method described above is provided. The laser machining system for laser machining a workpiece comprises: a laser machining head for radiating a laser beam with a core beam and a ring beam extending coaxially to the core beam onto at least one workpiece, and a control unit. The control unit is configured to carry out the method for laser machining according to one of the specific embodiments described here.

By radiating the laser beam onto the at least one workpiece, a laser machining process is carried out on the at least one workpiece, in that the material of the workpiece is heated so much by the incident laser power in an interaction area that it melts or even evaporates. The laser machining process, also referred to as a laser beam machining process, may include a laser welding process and/or a laser cutting process. For example, during laser welding, a weld seam may be formed between two workpieces to be welded. During laser cutting, a cutting edge for separating the workpiece may be formed on a workpiece.

Process radiation comprising plasma radiation in the visible wavelength range and thermal radiation in the infrared wavelength range is usually emitted from the interaction region. The process radiation generally also includes a portion of the laser beam which is reflected when the laser beam is radiated onto the at least one workpiece and which may also be referred to as a back reflection.

By adjusting the laser power of the core beam and/or adjusting the laser power of the ring beam as a function of the position of the laser beam on the workpiece, properties of the workpiece at this position may be taken into account when carrying out the laser machining process, in particular via rules. In particular, the laser power of the core beam and/or the laser power of the ring beam may be adjusted based on properties of the workpiece at that location, such as the thermal conductivity, the material and/or the thickness of the workpiece. The laser power of the core beam and/or the laser power of the ring beam can preferably be set or adjusted independently of one another. As a result, the machining quality of the laser machining process, in particular when laser welding workpieces made of different materials, with different thermal conductivities and/or different thicknesses, can be improved. For example, hot cracks during laser welding of workpieces made of aluminum alloys from the 6 or 7 series or high-strength steels can be prevented. When laser welding workpieces made of copper or copper alloys, spatter can be prevented or reduced. A machining speed can also be increased while the machining quality remains the same.

The aspects mentioned may include one or more of the following optional features.

The laser beam may be moved or guided along the machining path over the workpiece by deflecting the laser beam with respect to the workpiece by means of at least one deflector of the laser machining head. The laser machining head, through which the laser beam is radiated onto the workpiece, and the workpiece may accordingly be arranged in a stationary manner with respect to one another while the laser beam is being radiated onto the workpiece. Thus, the laser beam is preferably deflected along the machining path solely by the deflector. The deflector may also be referred to as a scanning device, scanner unit, scanner optics or scanner. The laser machining system may also be referred to as a scanner system.

As an alternative or in addition to deflecting the laser beam relative to the workpiece, the laser machining head may also be moved relative to the workpiece and/or the workpiece may be moved relative to the laser machining head. For example, the laser machining head may be moved by means of a robot of the laser machining system, to which the laser machining head is attached. The workpiece may be moved via an axis system or a workpiece table.

For example, the deflector may deflect the laser beam, with the robot moving at the same time or synchronously. As a result, machining time or cycle time can be saved. In this case, the control unit of the laser machining system may control the robot or the workpiece table and the deflector in order to coordinate the movements of the robot and the deflector.

The deflector may be configured to deflect the laser beam by a first deflection angle along at least a first axis. The deflector is preferably additionally configured to deflect the laser beam by a second deflection angle along a second axis, the first and second axes being arranged at an angle to one another, for example 90 degrees. The first and second maximum deflection angles may be predetermined by design. An area on the at least one workpiece or the surface thereof, within which the deflector can deflect the laser beam maximally with respect to the workpiece, may be specified by the maximum first and the maximum second deflection angle of the first deflector and a distance of the laser machining head from the workpiece and may be referred to as the scan field or machining field of the deflector or the laser machining head. The position of the laser beam in the scan field may also be referred to as the scanner position.

The deflector may be configured as a large field scanner. In this case, the maximum first deflection angle and/or the maximum second deflection angle of the deflector may be equal to or greater than 10 degrees, in particular 10 to 20 degrees. When the deflector has mirrors as deflection elements, these maximum deflection angles correspond to maximum mirror angles of at least 5 degrees, in particular 10 degrees, since the laser beam is deflected by twice the mirror angle. A length and/or a width of the scan field may be equal to or greater than 50 mm. The scan field may, for example, have a size of more than 50 mm×50 mm, in particular equal to or greater than approximately 100 mm×200 mm or 250 mm×150 mm, on the workpiece.

Alternatively, the deflector may be configured as a small field scanner. In this case, a maximum first deflection angle and/or a maximum second deflection angle of the deflector may each be less than 10 degrees and may preferably be less than 3 degrees, in particular approximately 2 degrees. A length and/or a width of the scan field on the workpiece may be less than 30 mm, preferably less than 15 mm, for example approximately 10 mm.

According to embodiments, the scan field has an elliptical shape. In this case, the length of the scan field may indicate the length of the major axis of the ellipse and the width of the scan field may indicate the length of the minor axis of the ellipse.

In order to induce the deflection of the laser beam, the deflector may have a first movable mirror and a second movable mirror. The first movable mirror can be rotated about a first axis of rotation and the second movable mirror can be rotated about a second axis of rotation, the first axis of rotation and the second axis of rotation being at an angle with respect to each other, e.g. at an angle between 45° and 135°, in particular from about 75° or 90°. For this purpose, the mirror or the first and second mirrors may be configured as galvanometer mirrors, or galvo mirrors for short. Alternatively, the deflector may have a movable mirror rotatable or pivotable about at least two axes. Accordingly, the deflector may be referred to as a galvanometer or galvo scanner. Alternatively, the deflector may have MEMS-based, piezo-electric and/or inductive drives. Alternatively, the deflector may be configured as a prism scanner or lens scanner.

The laser beam may be referred to as a ring mode laser beam. The core beam may have a substantially circular cross-section in a plane perpendicular to the direction of propagation of the laser beam. The ring beam may have a substantially annular cross-section in a plane perpendicular to the direction of propagation of the laser beam. The ring beam may be radially spaced from or adjacent to the core beam.

The laser machining system may comprise a laser source for generating the laser beam or for generating the core beam and ring beam together, and an optical fiber for transmitting these beams to the laser machining head. Alternatively, the laser source may also comprise a first laser source for generating the core beam and a second laser source for generating the ring beam. In this case, the core beam and the ring beam are generated in separate laser sources, wherein the core beam and the ring beam may then be coupled into a common optical fiber in order to form a (common) laser beam together and to be transmitted to the laser machining head. In this case, the laser power of the core beam and the laser power of the ring beam come from separate laser sources. The first and the second laser source may emit in different wavelength ranges or at different wavelengths. Correspondingly, the core beam and the ring beam may have different wavelengths.

The laser power of the laser beam may be the sum of the laser power of the core beam and the laser power of the ring beam. Laser power may denote the radiation intensity of the corresponding beam and may be specified in W/m².

The position of the laser beam on the workpiece may correspond to a point of incidence of the laser beam on the workpiece when the laser beam is radiated onto the workpiece and may correspond to a center point of the laser beam, in particular a center point of the core beam. The position of the laser beam on the workpiece may be a current position of the laser beam on the workpiece when the laser beam is radiated onto the workpiece.

The predetermined machining path may correspond to a course of a desired weld seam or cutting edge at or on the at least one workpiece. In laser welding, the machining path may also be referred to as a weld path. The position of the laser beam on the workpiece may correspond to a position on the machining path or may be associated with a position on the machining path. The machining path may be in the form of a line and may have a starting point and an end point. According to embodiments, the start point and the end point may coincide, i.e. in the case of a closed machining path. According to embodiments, the laser beam is moved from the start point to the end point along the machining path. The laser beam may also be turned off at least once between the starting point and the end point. The movement along the machining path may take place at a predetermined machining velocity. A machining velocity vector may be defined as a two-dimensional vector parallel to the surface of the at least one workpiece, which is tangential to the machining path at every position and the absolute value of which corresponds to the machining velocity at this position. The machining velocity may be constant or variable along the machining path.

Preferably, the laser power of the core beam and/or the laser power of the ring beam is adjusted when the laser beam is moved along the machining path. Accordingly, the laser power of the core beam and/or the laser power of the ring beam may be adjusted as a function of a position of the laser beam on the machining path.

The laser power of the core beam and/or the laser power of the ring beam may be adjusted repeatedly and/or periodically along the machining path. For example, the adjustment may take place at least twice and/or at at least two positions of the machining path, in particular at least three times and/or at at least three positions of the machining path. The adjustment of the laser power of the core beam and/or the laser power of the ring beam may be performed continuously or stepwise between two positions of the machining path.

Preferably, the machining path comprises a first area including and/or adjoining the starting point of the machining path and a second area including and/or adjoining the end point of the machining path, and setting the laser power of the core beam and/or the laser power of the ring beam is performed in a third area of the machining path between the first area and the second area.

During the movement of the laser beam along the machining path, the laser beam may preferably be moved along a predetermined wobble pattern on the at least one workpiece. The movement of the laser beam along the machining path may therefore be superimposed with a movement of the laser beam along the predetermined wobble pattern.

The movement of the laser beam along the wobble pattern may also be referred to as a wobble movement. The movement of the laser beam along the wobble pattern may be effected by deflecting the laser beam along the wobble pattern by means of the same deflector moving the laser beam along the machining path. Alternatively, the movement along the machining path and the movement along the wobble pattern may also be effected by two different deflectors of the laser machining head. For example, the movement along the machining path may be performed using a large field scanner as the first deflector and the movement along the wobble pattern may be performed using a small field scanner as the second deflector. The movement along the wobble pattern by the small field scanner and the movement along the machining path may also be performed by the previously described relative movement of the laser machining head and the at least one workpiece with respect to one another.

The wobble pattern, also known as a wobble figure, corresponds to an imaginary movement or deflection path of the laser beam on the workpiece without the laser beam moving along the machining path. The wobble figure may be viewed as a stationary figure in a moving coordinate system that moves across the workpiece at the specified machining velocity along the machining path.

A center point of the wobble pattern may coincide with the center or origin of the moving coordinate system. The wobble pattern may have a closed shape. In other words, a start point and an end point of the wobble pattern may coincide in the moving coordinate system. The wobble pattern may have the shape of a line, a figure eight, a peanut shape or a circle shape, for example.

The laser beam may be repeatedly moved along the wobble pattern. Accordingly, the wobbling movement may be viewed as an oscillating, or repeated or uniform, deflection or movement of the laser beam relative to movement along the machining path. This results in a periodic or oscillating movement of the position of the laser beam in at least one of the coordinate axes over time in the moving coordinate system and/or a coordinate system fixed with respect to the at least one workpiece.

The position of the laser beam on the workpiece may correspond to or be associated with a position of the laser beam in the wobble pattern. The laser power of the core beam and/or the laser power of the ring beam may be adjusted when moving the laser beam along the wobble pattern. According to embodiments, the laser power of the core beam and/or the laser power of the ring beam may be adjusted according to a position of the laser beam in the wobble pattern.

The wobble pattern may include a first position in advance of the machining path and/or a second position in the wake of the machining path. The first position may correspond to an intersection of the wobble pattern with the machining path when the machining path is followed in the machining direction starting from the origin of the moving coordinate system. The second position may correspond to an intersection of the wobble pattern with the machining path when the machining path is followed in the opposite machining direction, starting from the origin of the moving coordinate system. The first position in advance may be in a first, non-machined area of the workpiece, i.e. the laser beam has not yet been incident on the first position. The second position in the wake may be in a second, already machined area of the workpiece, i.e. the laser beam has already been incident on the second position and the material has already been melted and may have already cooled down again. For example, in the case of laser welding, the weld seam may already be formed in the second area of the workpiece. Due to melting and cooling, the material of the workpiece has changed at the second position in the wake. Typically, the thermal conductivity of the modified material at the second position in the wake is less than the thermal conductivity of the material at the first position in advance. Accordingly, the laser power of the core beam at the first position may be set or adjusted to be greater than the laser power of the core beam at the second position in the wake. Alternatively or additionally, the laser power of the ring beam at the first position may be set or adjusted to be greater than the laser power of the ring beam at the second position in the wake.

The wobble pattern may also include at least one lateral position to the side of the machining path, i.e. next to the machining path or outside of the machining path. The laser power of the core beam may be set or adjusted to be smaller at the lateral position than the laser power of the core beam at the first position in advance and/or at the second position in the wake. As an alternative or in addition, the laser power of the ring beam at the lateral position may be set or adjusted to be less than the laser power of the ring beam at the first position in advance and/or in the second position in the wake. The at least one lateral position on the wobble pattern may correspond to an intersection of the wobble pattern with a line extending perpendicular to the machining path through the origin of the moving coordinate system.

The laser power of the core beam and/or the laser power of the ring beam may be adjusted based on properties of the workpiece at the position of the laser beam. For example, the laser power may be adjusted based on a thermal conductivity, a thickness, and/or a material of the workpiece at the position of the laser beam, and/or the laser power may be adjusted based on whether the workpiece has already been processed or has not yet been processed at the position of the laser beam before the laser beam is radiated onto this position.

The laser power of the core beam and/or the laser power of the ring beam may be adjusted in proportion to the thickness and/or the thermal conductivity of the workpiece at the position, for example. In other words, the laser power of the core beam and/or the laser power of the ring beam may be adjusted to be greater with increasing thickness and/or increasing thermal conductivity of the workpiece. Alternatively or additionally, a difference between the relative laser power of the ring beam and the relative laser power of the core beam may be adjusted in inverse proportion to the thickness and/or the thermal conductivity of the workpiece. In other words, the difference between the relative laser power of the ring beam and the relative laser power of the core beam may be adjusted to be smaller with increasing thickness and/or increasing thermal conductivity of the workpiece. The relative laser power of the core beam or ring beam may be defined as the (currently) set laser power in relation to the maximum or maximum possible laser power and may be specified, for example, as a percentage of the maximum laser power.

The thermal conductivity at the position may be a specific thermal conductivity of the material of the workpiece at the position of the laser beam or an absolute thermal conductivity of the workpiece at the position of the laser beam. The absolute thermal conductivity may depend, for example, on the material of the workpiece at the position, in particular its specific thermal conductivity, and the geometry of the workpiece at the position, for example the thickness. The thickness of the workpiece may be specified or defined along an axis parallel to a direction of propagation or radiation of the laser beam onto the workpiece. Alternatively, the thickness of the workpiece may be specified or defined along a normal to the workpiece surface at this point.

When the specified machining path extends along an abutting edge of two workpieces to be machined, in particular two workpieces to be welded, the laser power of the core beam and/or the laser power of the ring beam may be adjusted in proportion to a thickness of at least one of the workpieces along the machining path. Alternatively or additionally, a difference between the laser power of the ring beam and the laser power of the core beam may be adjusted in proportion to a thickness of at least one of the workpieces along the machining path.

The laser power of the core beam and the laser power of the ring beam may be independently settable or adjustable. The laser power of the core beam and the laser power of the ring beam are preferably adjusted or set independently of one another, in particular independently of one another in terms of time. The laser power of the core beam and/or the laser power of the ring beam may be adjusted or set in particular while the laser beam is being radiated onto the at least one workpiece. As a result, the laser power of the core beam and the laser power of the ring beam do not have to be set in advance. This also makes it possible to control the regulation of the laser power of the core beam and the laser power of the ring beam while the laser machining process is being carried out.

According to embodiments, a quotient of the laser power of the core beam and the laser power of the ring beam may be constant during the movement of the laser beam along the machining path and/or along the wobble pattern. Alternatively or additionally, a sum of the laser power of the core beam and the laser power of the ring beam may be constant during the movement of the laser beam along the machining path and/or along the wobble pattern.

The laser machining head preferably comprises collimation optics for adjusting the focal position of the laser beam. The collimation optics may be adjustable along an optical axis of the collimation optics and/or along a beam propagation direction of the laser beam in order to set the focal position of the laser beam. The control unit may control the collimation optics to adjust the focal position of the laser beam or control it, for example, on the basis of a distance signal. The control unit may be configured to control a focal position (preferably in real time) based on distance measurements, in particular continuous distance measurements.

The laser machining head preferably further comprises focusing optics for focusing the laser beam. In particular, the focusing optics may be configured to focus the laser beam on the workpiece, in particular on a surface of the at least one workpiece. The focusing optics may include an F-Theta lens or be configured as such. The F-theta lens may be telecentric.

The control unit may be configured to control the laser machining system or elements thereof, in particular the laser machining head, the deflector, the focusing optics, the collimation optics and the laser source, in order to carry out the laser machining method and the laser machining process. In particular, the control unit may be configured to adjust or set the laser power of the core beam and/or the laser power of the ring beam by controlling the at least one laser source. The control unit may also be configured to move the laser beam along the machining path and/or along the wobble pattern or within the scan field by controlling the at least one deflector and possibly the robot, the axis system and the tool table.

The control of the laser source to adjust the laser power of the core beam and the ring beam, the control of the first laser source to adjust the laser power of the core beam, or the control of the second laser source to adjust the laser power of the ring beam may each be carried out via an analogue interface, for example by adjusting the current and/or voltage, or via a digital interface.

The laser machining system, in particular the control unit of the laser machining system, may be programmed to carry out the method of laser machining, in particular to carry out the laser machining process and to adjust the laser power of the ring beam and/or the laser power of the core beam. The adjustment of the laser power of the core beam and/or the ring beam may also be referred to as power modulation of the core beam or the ring beam. The power modulation may be programmed via a graphical user interface.

In particular, the machining path and/or the wobble pattern may be stored in the control unit, or the control unit may be programmed with the machining path and/or the wobble pattern. The machining path and/or the wobble pattern may be programmed via a graphical user interface of the laser machining system or the control unit.

The laser power of the core beam and/or the laser power of the ring beam may also be stored in the control unit depending on or as a function of a position of the laser beam on the at least one workpiece, the position of the laser beam on the machining path and/or the position of the laser beam on the wobble pattern, or the control unit may be programmed therewith. Alternatively or additionally, the laser power of the core beam and/or the laser power of the ring beam may be stored in the control unit depending on or as a function of properties of the workpiece along the machining path and/or the wobble pattern, or the control unit may be programmed therewith. For example, a trained neural network, an analytical function or a table may be stored in the control unit.

The at least one workpiece may be a metallic workpiece. The at least one workpiece may consist of or include copper, aluminum, steel or an alloy with these materials. In particular, the at least one workpiece may consist of a high-strength steel. Alternatively, the workpiece may be made of a 6 or 7 series aluminum alloy.

According to embodiments, during laser welding at least two workpieces may be arranged in a parallel joint or lap joint and the at least two workpieces may be welded to one another by forming an I-seam or fillet weld. According to other embodiments, at least two workpieces may be arranged in a butt joint during laser welding and the at least two workpieces may be joined to one another by forming an I-seam. However, the present disclosure is not limited thereto.

When laser welding, the at least one workpiece may include a first workpiece and a second workpiece. The first workpiece may be made of aluminum or an aluminum alloy, for example, and the second workpiece may be made of copper or a copper alloy. The first workpiece and the second workpiece may be arranged in a butt-joint and the machining path may be disposed at a joint edge of the first workpiece and the second workpiece. The movement along the machining path may preferably be superimposed with a movement along the wobble pattern. A first lateral position of the wobble pattern may be on the first workpiece and a second lateral position may be on the second workpiece. The laser power of the core beam may be set to be smaller at the first lateral position than at the second position, and/or the laser power of the ring beam may be set to be smaller at the first lateral position than at the second position.

When laser welding, the at least one workpiece may include a first workpiece and a second workpiece. The first workpiece may have a first thickness and the second workpiece may have a second thickness, the first thickness being less than the second thickness. The first workpiece and the second workpiece may be arranged in a butt-joint and the machining path may be disposed at a joint edge of the first workpiece and the second workpiece. The movement along the machining path may preferably be superimposed with a movement along the wobble pattern. A first lateral position of the wobble pattern may be on the first workpiece and a second lateral position may be on the second workpiece. The laser power of the core beam may be set to be smaller at the first lateral position than at the second position and/or the laser power of the ring beam may be set to be smaller at the first lateral position than at the second position.

The method of laser machining may also include acquiring monitoring parameters for monitoring the laser machining process. The laser power of the core beam and/or the laser power of the ring beam may be adjusted as a function of the acquired monitoring parameters. The monitoring parameters may include, for example, intensities of process radiation in different wavelength ranges or the like. For this purpose, the laser machining system may include a photodiode monitoring system. The photodiode monitoring system may, for example, use photodiodes to record and evaluate the process radiation of the laser machining process in different wavelength ranges or at different wavelengths. Furthermore, the laser machining system may include a camera monitoring system. For example, the camera monitoring system may capture and evaluate photos of a workpiece surface including the interaction area of the laser machining process during the laser machining process. The position of the laser beam on the at least one workpiece may be detected and monitored using the camera monitoring system. Furthermore, the laser machining system may include an OCT (“Optical Coherence Tomography”) monitoring system. The OCT system may be used, for example, to detect and monitor a distance between the laser machining head and the at least one workpiece. The quality of the laser machining process may be monitored using these monitoring systems.

The method may further include collecting and storing the laser powers of the laser beam and/or the core beam and/or the ring beam set during the laser machining process, and/or the positions adopted by the laser beam on the workpiece, and/or settings of the deflector(s) and/or the results of quality monitoring via the above-described monitoring system by means of a central unit, for example the control unit. The method may also correlate the laser powers of the laser beam and/or the core beam and/or the ring beam set during the laser machining process, and/or the positions adopted by the laser beam on the workpiece, and/or settings of the deflector(s) with the results of quality monitoring using neural networks.

### BRIEF DESCRIPTION OF THE DRAWINGS

The invention is described in detail below with reference to figures.

FIG. 1 shows a schematic view of a laser machining system according to embodiments of the present disclosure;

FIG. 2 shows a flow diagram of a method of laser machining according to embodiments of the present disclosure;

FIG. 3 shows a top view of workpieces for illustrating a method of laser machining according to embodiments of the present disclosure;

FIG. 4A shows a schematic perspective view and FIG. 4B shows a top view of workpieces for illustrating a method according to further embodiments of the present disclosure;

FIG. 5 shows a top view of a workpiece illustrating a machining path and a wobble pattern of a method of laser machining according to embodiments of the present disclosure; and

FIGS. 6A-6D show top views of a workpiece illustrating a method of laser machining according to embodiments of the present disclosure.

### DETAILED DESCRIPTION OF THE INVENTION

Hereinafter, the same reference symbols denote elements that are the same or have the same effect, and a duplicate description of these elements is omitted.

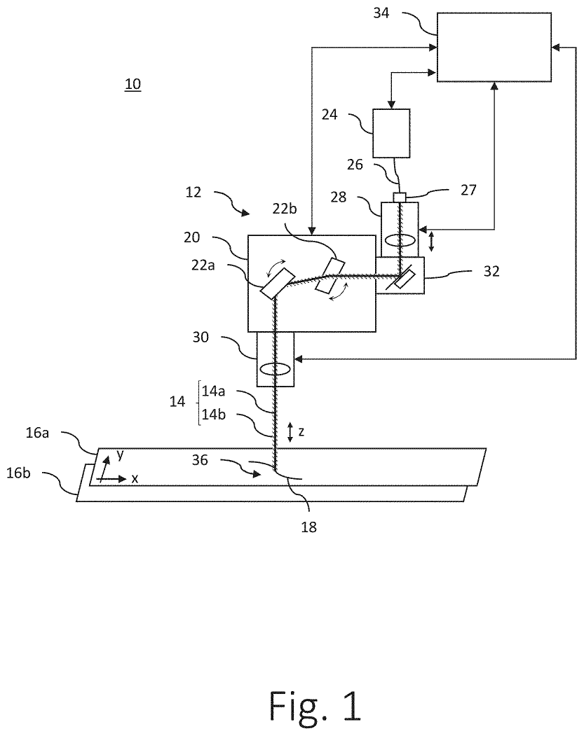

FIG. 1 shows a schematic view of a laser machining system according to embodiments of the present disclosure. The laser machining system 10 includes a laser machining head 12 for radiating and directing a laser beam 14 onto at least one workpiece 16a, 16b. As explained in detail with reference to the following figures, the laser beam 14 comprises, at least after exiting the laser machining head 12 and when incident on the at least one workpiece 16a, 16b, a core beam 14a and a ring beam 14b extending coaxially to the core beam which are directed onto the workpiece 16a, 16b.

By radiating the laser beam 14 onto the at least one workpiece 16a, 16b, a laser machining process is carried out on the at least one workpiece 16a, 16b, in that the material of the workpiece is heated so much by the radiated laser power in an interaction area that it melts or even evaporates. The laser machining process may include a laser welding process and/or laser cutting process. Process radiation (not shown) comprising plasma radiation in the visible wavelength range and thermal radiation in the infrared wavelength range is usually emitted from the interaction region. The process radiation generally also includes a portion of the laser beam 14 reflected when the laser beam 14 is radiated onto the at least one workpiece 16a, 16b, which portion may also be referred to as a back reflection.

According to embodiments, the at least one workpiece 16a, 16b is a metallic workpiece. The at least one workpiece 16a, 16b may consist of or include copper, aluminum, steel or an alloy with these materials, for example. The at least one workpiece 16a, 16b may comprise, for example, a high-strength steel or an aluminum alloy from the 6 or 7 series.

The point of incidence 36 of the laser beam 14 on the workpiece 16a, 16b may also be referred to as the position of the laser beam 14 on the workpiece 16a, 16b and may correspond to a center point of the laser beam 14, in particular a center point of the core beam 14a. The position of the laser beam 14 may be specified in a two-dimensional x-y Cartesian coordinate system that is parallel to a surface of the at least one workpiece 16a, 16b and is stationary or fixed with respect to the at least one workpiece 16a, 16b.

When the laser beam 14 is radiated, the laser beam 14 is moved along a machining path 18 predetermined for this laser welding process. The machining path 18 is arranged on the at least one workpiece 16a, 16b or defined with respect to the at least one workpiece 16a, 16b. For example, the machining path 18 is defined in the x-y coordinate system. According to embodiments, the machining path 18 is arranged on two workpieces 16a, 16b or at a boundary or abutting edge between the two.

As shown by way of example in FIG. 1, the laser machining system 10 is configured to carry out laser welding or a laser welding process for welding two workpieces 16a, 16b. However, the present disclosure is not limited thereto. The laser machining system 10 may also be a laser cutting system for carrying out a laser cutting process on at least one workpiece. The two workpieces 16a, 16b are configured as metal sheets and are arranged in a lap joint, and the laser beam 14 is radiated onto the workpiece 16a lying on top, which may also be referred to as the upper sheet. In this embodiment, the predetermined machining path 18 indicates the course of a desired weld seam formed by the cooled material of the workpieces 16a, 16b for joining the workpieces 16a, 16b. In the example shown in FIG. 1, an I-seam is to be formed on the workpieces 16a, 16b.

In order to change the position of laser beam 14 on the at least one workpiece 16a, 16b, and in particular to guide laser beam 14 along the machining path 18, the laser machining system 10 includes a deflector 20 for deflecting or deflecting laser beam 14 with respect to or relative to the at least one workpiece 16a, 16b. The deflector 20 is configured, for example, to move or deflect the laser beam 14 along the axes of the x-y coordinate system. The deflector 20 may also be referred to as a scanner unit or scanner. Using the deflector 20, the predetermined machining path 18 can be travelled by the laser beam 14.

The laser machining head 12, through which the laser beam 14 is radiated onto the workpieces 16a, 16b, and the workpieces 16a, 16b may accordingly be arranged stationary with respect to one another while the laser beam 14 is radiated. In this case, the laser beam 14 is deflected along the machining path 18 solely by the deflector 20. Alternatively or in addition to deflecting the laser beam 14 with respect to the workpieces 16a, 16b, the laser machining head 12 may also be moved relative to the workpiece 16a, 16b and/or the workpiece 16a, 16b may be moved relative to the laser machining head 12 in order to effect the movement of the laser beam 14 along the machining path 18. For example, the laser machining head 12 may be moved by means of a robot (not shown) of the laser machining system 10 to which the laser machining head 12 is attached. The workpieces 16a, 16b may be moved by means of an axis system or a workpiece table (not shown).

In order to effect the deflection of the laser beam 14, the deflector 20 comprises a first movable mirror 22a and a second movable mirror 22b. The first moveable mirror 22a may be rotatable about a first axis of rotation and the second moveable mirror 22b may be rotatable about a second axis of rotation, the first axis of rotation and the second axis of rotation being at an angle with respect to each other, e.g., at an angle between 45° and 135° , in particular of about 75 ° or 90 °. For this purpose, at least one of the first and second mirrors 22a, 22b may be configured as a galvanometer mirror, or galvo mirror for short. Alternatively, the deflector 20 may include a movable mirror rotatable or pivotable about at least two axes. Accordingly, the deflector may be referred to as a galvanometer or galvo scanner.

The deflector 20 has a maximum first deflection angle by which the laser beam 14 can be deflected along a first axis, for example the x-axis, and a maximum second deflection angle by which the laser beam 14 can be deflected along a second axis, for example the y-axis that. The first and the second maximum deflection angles may be predetermined by design. Alternatively, an F-theta lens used as focusing optics 30 may limit the maximum deflection angle. An area on the at least one workpiece 16a, 16b or the surface thereof, within which the deflector 20 can maximally deflect the laser beam with respect to the workpiece 16a, 16b, may be predetermined by the maximum first and the maximum second deflection angle of the deflector 20 and a distance of the laser machining head 12 from the workpiece 16a, 16b and may be referred to as the scan field of the deflector 20.

According to embodiments, the deflector 20 is configured as a large field scanner. In this case, the maximum first deflection angle and/or the maximum second deflection angle of the deflector 20 may be equal to or greater than 10 degrees, in particular 10 to 20 degrees. For the embodiment shown in FIG. 1, these maximum deflection angles correspond to maximum mirror angles of at least 5 degrees, in particular 10 degrees, since the laser beam 14 is deflected by twice the mirror angle due to the law of reflection. Alternatively, the deflector 20 may be configured as a small field scanner. In this case, a maximum first deflection angle and/or a maximum second deflection angle of the deflector may each be less than 10 degrees and may preferably be less than 3 degrees, in particular approximately 2 degrees. In this case, as described above, in order to move the laser beam 14 along the machining path 18, preferably the laser beam 14 is deflected by the deflector 20 and the laser machining head 12 and the workpieces 16a, 16b are moved relative to one another as well.

According to alternative embodiments that are not shown, the deflector 20 may comprise a first deflector configured as a large field scanner and a second deflector configured as a small field scanner. As described above, the first deflector may preferably be used for movement along the machining path 18 and the second deflector may be used for a wobbling movement of the laser beam 14 as described in detail below.

The laser welding system 10 can include a laser source 24 for generating the laser beam 14, also referred to as a machining laser beam. The laser source 24 may be a diode laser, a solid state laser, or a fiber laser, but the present disclosure is not limited thereto. The laser welding system 10 may further include an optical fiber 26 for transmitting the laser beam 14 with the core beam 14a and the ring beam 14b from the laser source 24 to the laser welding head 12 and for coupling it into the laser machining head 12. For this purpose, the laser beam 14 is coupled into the laser welding head 12 from one end of the optical fiber 26, e.g. by means of a fiber coupler 27. For transmitting the core beam 14a and the ring beam 14b, the optical fiber 26 may include a core and a cladding.

The laser beam 14 includes the core beam 14a and the ring beam 14b. The laser beam 14 30 may thus be a ring-mode laser beam. The core beam 14a may have a substantially circular cross-section in a plane perpendicular to the direction of propagation. The ring beam 14b may have a substantially annular cross-section in a plane perpendicular to the propagation direction. The ring beam 14b may be spaced apart from the core beam 14a in the radial direction or may be adjacent to the core beam 14a. At least, however, there are two intensity maxima in a plane perpendicular to the direction of propagation, namely a circular intensity maximum of the core beam in the center and a ring-shaped intensity maximum of the ring beam arranged concentrically thereto.

According to embodiments, the laser source 24 is configured to generate both the core beam and the ring beam, and the optical fiber 26 is configured to transmit the core beam and the ring beam to the laser machining head 12.

According to alternative embodiments, the laser source 24 comprises a first laser source for generating the core beam 14a and a second laser source for generating a ring beam 14b (both not shown). In this case, the core beam and the ring beam are thus generated in different laser sources, with the core beam 14a and the ring beam 14b then being coupled into a common optical fiber in the laser source 24, where they together form the (common) laser beam 14. The core beam 14a and the ring beam 14b are then transmitted to the laser machining head 12 by the optical fiber 26. In this case, the laser power of the core beam 14a and the laser power of the ring beam 14b come from separate laser sources. The first and second laser sources may emit in different wavelength ranges or at different wavelengths. Correspondingly, the core beam 14a and the ring beam 14b may have different wavelengths.

Alternatively, the laser source 24 may also generate a conventional simple laser beam and the laser beam may be transmitted to the laser machining head 12 by means of the optical fiber 26. In this case, the split of the laser beam 14 into a core beam and a ring beam may be performed by appropriate optics (not shown) in the laser machining head 12.

Collimation optics 28 arranged downstream of the fiber coupler 27 is configured to collimate the laser beam 14 emerging divergently from the end of the optical fiber 26. The focal position of the laser beam 14 may be adjusted or corrected using the collimation optics 28. The axis along which a focal position of the laser beam 14 can be adjusted may correspond to an optical axis of the laser welding head 12, in particular an optical axis of a focusing optics 30. This axis may also be referred to as the z-axis. For example, the z-axis may be perpendicular to the axes of the x-y coordinate system. Accordingly, the collimator optics 28 may be referred to as z-collimator optics, or z-collimation for short. The focal position may be adjusted by adjusting a lens of the collimator optics 28 along the optical axis of the collimator optics 28 or a beam axis of the laser beam 14. The collimating optics 28 may include a motor unit (not shown) for adjusting the lens.

In addition, the laser machining head 12 may have an aperture in the beam propagation direction of the laser beam 14 downstream of the end of the optical fiber 26, for example in or behind the fiber coupler 27. Using the aperture, undesired modes of the laser beam 14, in particular of the ring beam 14b, may be blanked out or suppressed since the ring beam 14b may be strongly divergent after exiting the end of the optical fiber 26.

The laser machining head 12 further includes a coupling device 32 for coupling the laser beam 14 into the deflector 20. The coupling device 32 is configured, for example, as a beam splitter or dichroic mirror, essentially reflecting light with the wavelength of the laser beam 14 and essentially transmitting light with a different wavelength than that of the laser beam 14, i.e. the mirror is essentially transparent for light with a different wavelength than that of the laser beam 14. Using the coupling device 32, process radiation which is generated when the laser beam 14 is radiated onto the workpieces 16a, 16b and is coupled into the laser machining head 12, can be separated from the laser beam 14 and decoupled from the laser machining head 12 in order to be available for monitoring the laser machining process.

Furthermore, the laser welding head 12 includes focusing optics 30 for focusing the laser beam 14 on the at least one workpiece 16a, 16b, in particular on a surface of the at least one workpiece 16a, 16b. According to embodiments, the focusing optics 30 is configured as an F-Theta lens. The f-theta lens may be telecentric.

The laser machining system 10 may include various monitoring systems (not shown) for monitoring the laser machining process. The monitoring may be based on the process radiation coupled out of the laser machining head 12 by the coupling device 32. For example, the laser machining system 10 may include a photodiode monitoring system. The photodiode monitoring system may use photodiodes to sense and evaluate the process radiation of the laser machining process in different wavelength ranges or at different wavelengths. In this way, for example, the plasma radiation, the temperature radiation and the back reflection may be sensed and evaluated. Furthermore, the laser machining system 10 may include a camera monitoring system. The camera monitoring system may capture and evaluate photos of a workpiece surface including the interaction area during the laser machining process. The position of the laser beam 14 on the workpiece 16a, 16b can thus be detected and monitored. Furthermore, the laser machining system 10 may include an OCT (“Optical Coherence Tomography”) monitoring system. The OCT system may be used, for example, to detect and monitor a distance between the laser machining head 12 and the at least one workpiece 16a, 16b. In a laser welding process, the depth of a vapor capillary may also be sensed and monitored.

The laser machining system 10 further comprises a control unit 34 for controlling the components of the laser machining system 10 in order to carry out the laser machining process and the method of laser machining described above according to embodiments of the present disclosure. The control unit 34 is configured to control the laser source 24, the collimation optics 28 and the deflector 20. In particular, the control unit 34 is configured to control the collimation optics 28 in order to adjust a focal position of the laser beam 14. Furthermore, the control unit 34 is configured to control the deflector 20 in order to deflect the laser beam 14 with respect to the workpiece 16a, 16b and to guide it along the machining path 18 and the wobble pattern described later, and the control unit 34 is configured to control the laser source 24 in order to set and adjust the laser power of the laser beam 14, the laser power of the ring beam 14a and/or the laser power of the core beam 14b. The control unit 34 may further also be configured to control the robot, the axis system and/or the tool table in order to guide the laser beam 14 along the machining path 18 and the wobble pattern.

The control unit 34 is therefore configured, on the one hand, to control the position of the laser beam 14 on the workpiece 16a, 16b or in the scan field and, at the same time, to transmit power specifications for the core beam 14a and the ring beam 14b to the laser source 24, in particular a control unit (not shown) of the laser source 24.

The control unit 34 may be programmed or programmable to carry out the laser machining method, in particular to carry out the laser machining process and to adjust the laser power of the ring beam 14b and/or the laser power of the core beam 12a. For example, the predetermined machining path 18 and a predetermined wobble pattern may be stored in the control unit 34 or the control unit 34 may be programmed therewith. In addition, the control unit 34 may be programmed to adjust the laser power of the laser beam 14, the laser power of the core beam 14a and/or the laser power of the ring beam 14b, collectively also referred to as power modulation.

For example, the laser power of the laser beam 14, the laser power of the core beam 14a and/or the laser power of the ring beam 14b may be predetermined depending on or as a function of a position of the laser beam 14 on the at least one workpiece 16a, 16b, the position of the laser beam 14 on the machining path 18 and/or the position of the laser beam 14 on the wobble pattern 19 and stored in the control unit 34, or the control unit 34 may be programmed therewith. Alternatively or additionally, the laser power of the laser beam 14, the laser power of the core beam 14a and/or the laser power of the ring beam 14b may be stored in the control unit 34 as a function of properties of the workpiece 16a, 16b along the machining path 18 and/or the wobble pattern 19 or the control unit 34 may be programmed therewith. For example, an analytical function or a table may be stored in the control unit 34.

Thus, the laser machining system 10 of FIG. 1 is configured to perform the method of laser machining according to embodiments of the present disclosure.

The control unit 34 may further be configured to receive monitoring data from the monitoring systems described above and to control the laser machining process and/or the power modulation based thereon.

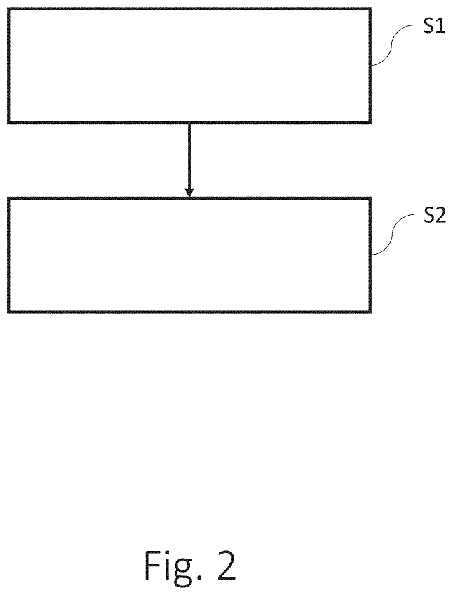

FIG. 2 shows a flow diagram of a method of laser machining according to embodiments of the present disclosure. The method of laser machining a workpiece may be carried out using the laser machining system 10 described in FIG. 1 and comprises the following steps.

In order to carry out a laser machining process, a laser beam is radiated onto at least one workpiece. The laser beam comprises a core beam and a ring beam which are coaxial to one another. The laser beam is guided over the workpiece along a predetermined machining path (S1). When the laser beam I radiated onto the at least one workpiece, a laser power of the laser beam, a laser power of the core beam and/or a laser power of the ring beam is adjusted or set dependent on or as a function of a position of the laser beam on the at least one workpiece or a position of the laser beam in the scan field (S2). In particular, the laser power of the laser beam, the laser power of the core beam and/or the laser power of the ring beam may be adjusted depending on or as a function of a position of the laser beam on the machining path and/or a position of the laser beam on a wobble pattern.

According to embodiments, the laser power of the laser beam, the laser power of the core beam and/or the laser power of the ring beam is adjusted based on properties of the workpiece at the position of the laser beam on the workpiece. For example, the laser power may be adjusted based on a thermal conductivity, a thickness and/or a material of the workpiece at the position of the laser beam, and/or the laser power may be adjusted based on whether the workpiece was already machined or is still unmachined at the current position of the laser beam before being radiated by the laser beam.

The thermal conductivity at the position may be a specific thermal conductivity of the material of the workpiece at the position or an absolute thermal conductivity of the workpiece at the position. The absolute thermal conductivity may depend, for example, on the material of the workpiece at the position and the geometry of the workpiece at the position, e.g. the thickness, and the specific thermal conductivity. The thickness of the workpiece may be specified or measured along an axis parallel to a direction of propagation or incidence of the laser beam on the workpiece.

The laser power of the core beam and the ring beam laser power may be independently adjustable or settable. According to embodiments, the laser power of the core beam and the laser power of the ring beam are preferably adjusted or set independently of one another, in particular independently of one another in terms of time. Alternatively or additionally, the laser powers may also be adjusted at the same time and/or adjusted by the same percentage amount.

The laser power of the core beam and/or the laser power of the ring beam may be adjusted continuously or stepwise between two positions of the laser beam on the workpiece.

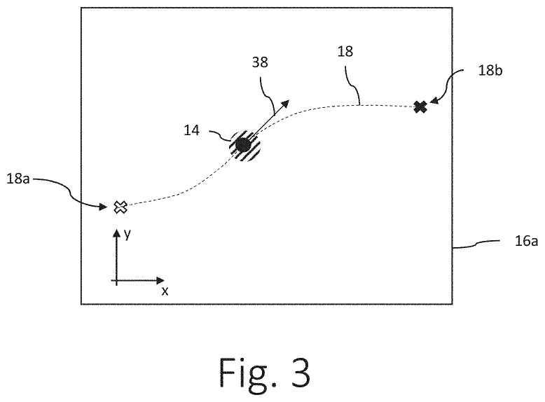

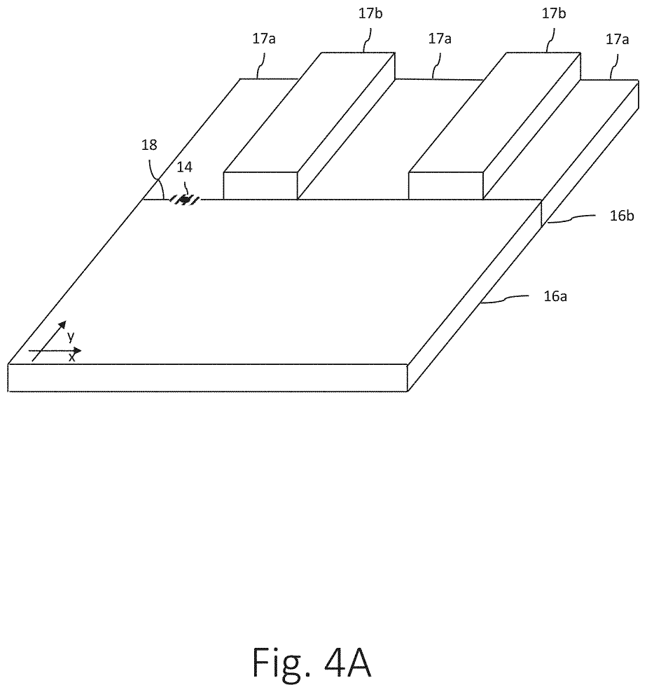

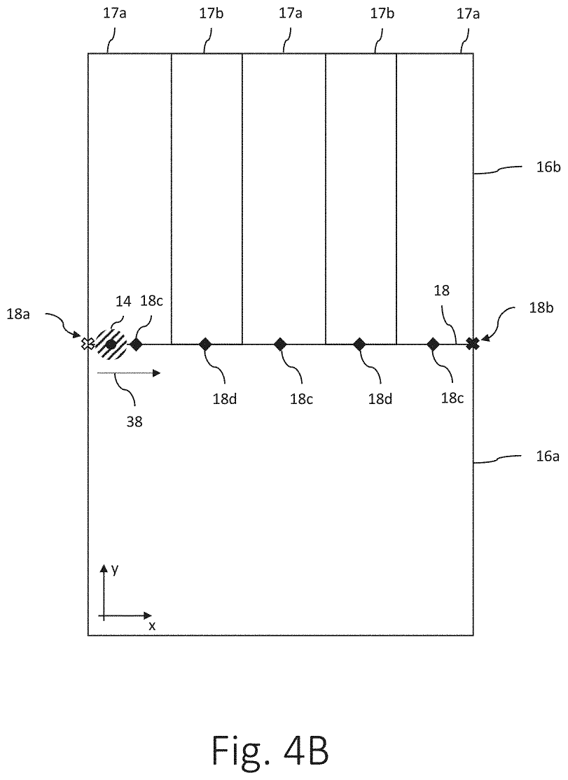

FIG. 3 shows a top view of workpieces for illustrating a method of laser machining according to embodiments of the present disclosure, and FIG. 4A shows a schematic perspective view and FIG. 4B shows a top view of workpieces for illustrating a method according to further embodiments of the present disclosure.

FIG. 3 shows a top view of the workpiece 16a lying on top of the workpieces 16a, 16b of FIG. 1 arranged in a lap joint. FIG. 4 shows an embodiment in which the workpieces 16a, 16b are arranged in a butt joint. In both embodiments, the workpieces 16a, 16b are to be welded to one another by a weld seam that is to extend along the predetermined machining path 18. The predetermined machining path 18 therefore indicates the course of a desired weld seam. In FIG. 3, the weld is to be on a surface of the workpiece 16a. In FIGS. 4A, 4B, the weld seam to be formed should extend along the abutting edge of the workpieces 16a, 16b.

In FIGS. 4A, 4B, the workpiece 16b has areas or portions with different thicknesses. The areas 17a of the workpiece 16b have a smaller thickness than the areas 17b. The workpiece 16a has a substantially constant thickness. The thickness of the workpiece 16a may, for example, correspond to the thickness of the areas 17a of the workpiece 16b.

When the laser beam 14 is radiated onto the workpiece 16a to carry out the laser machining process and to form the weld seam, the laser beam 14 is guided along the predetermined machining path 18 from a starting point 18a to an end point 18b of the machining path 18. The machining path 18 is usually line-shaped.

The position of the laser beam 14 on the workpiece 16a may correspond to a position on the machining path 18 or may be associated with a position on the machining path 18. The laser beam 14 is moved along the machining path 18 at a predetermined machining velocity which may be constant or variable along the machining path 18. A machining velocity vector 38 may be defined as a two-dimensional vector parallel to the surface of the workpiece 16a, or in the x-y coordinate system stationary with respect to the workpiece 16a, said vector extending tangentially to the machining path 18 at every position of the laser beam 14 and the absolute value thereof corresponding to the machining velocity at this position. The orientation of the machining velocity vector 38 may also be referred to as the machining direction. In a laser welding process, the machining direction may also be referred to as the welding direction and the machining path 18 may be referred to as the welding track.

According to the embodiments shown in FIGS. 3 and 4A and 4B, the laser power of the core beam and/or the laser power of the ring beam is adjusted when the laser beam 14 is moved along the machining path 18. Accordingly, the laser power of the core beam and/or the laser power of the ring beam is adjusted as a function of a position of the laser beam 14 on the machining path 18. The laser powers may be adjusted at the position of the laser beam 14 based on the properties of the workpieces 16a, 16b mentioned with reference to FIG. 2, in particular the thickness, the thermal conductivity and/or the material of the workpieces 16a, 16b.

The laser power of the core beam and/or the laser power of the ring beam may be adjusted continuously or stepwise between two positions of the machining path 18. The adjustment of the laser power of the core beam and/or the laser power of the ring beam along the machining path 18 may be performed repeatedly and/or periodically. For example, the adjustment may be performed at least three times or at three different positions on the machining path 18. The power specifications in this disclosure relate to the respective maximum power of the ring beam or core beam. Preferably, with a larger material or workpiece thickness, higher laser power is set for core beam and/or ring beam. The ratio of the laser powers between the core beam and the ring beam may preferably be changed or adjusted according to the application, i.e. the core beam and ring beam laser power may be modulated independently.

For example, in FIGS. 4A and 4B, the laser power of the core beam and/or the laser power of the ring beam is adjusted in proportion to a thickness of at least one of the workpieces 16a, 16b along the machining path 18. Alternatively or additionally, a difference between the laser power of the ring beam and the laser power of the core beam may be adjusted in proportion to a thickness of at least one of the workpieces 16a, 16b along the machining path 18.

For example, at the positions 18c on the machining path 18, the laser power of the core beam is set to 30% with respect to a maximum laser power of the core beam and the laser power of the ring beam is set to 30% with respect to a maximum laser power of the ring beam. At the positions 18d on the machining path 18, the laser power of the core beam is set to 40% with respect to a maximum laser power of the core beam and the laser power of the ring beam is set to 50% with respect to a maximum laser power of the ring beam. The set laser power of the core beam with respect to the maximum laser power of the core beam may also be referred to as the relative laser power of the core beam. This applies analogously to the ring beam.

Hence, the difference between the relative laser power of the core beam and the relative power of the ring beam at the positions 18c is zero and the difference at the positions 18d is not equal to zero or greater than zero, for example 10%. The positions 18c on the machining path 18 adjoin the areas 17a of the workpiece 16b which have the same thickness as the workpiece 16a. The positions 18d adjoin the areas 17b of the workpiece 16b, which have the increased thickness compared to the areas 17a. As described above, the laser power of the core beam and the ring beam may be adjusted or changed continuously or stepwise between two consecutive positions 18c, 18d along the machining path.

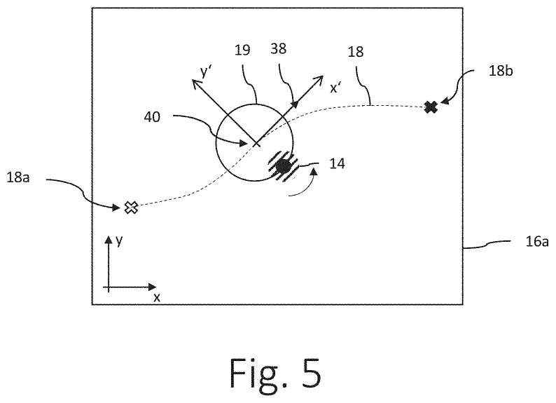

During the movement of the laser beam along a machining path, the laser beam can also be moved along a predetermined wobble pattern on the at least one workpiece. FIG. 5 shows a top view of a workpiece for illustrating a machining path and a wobble pattern of a method for laser machining according to embodiments of the present disclosure.

The movement of the laser beam 14 along the machining path 18 is superimposed with a movement of the laser beam 14 along the predetermined wobble pattern 19. The movement of the laser beam 14 along the wobble pattern 19 may also be referred to as a wobble movement. The wobble pattern corresponds to an imaginary path of movement or deflection of the laser beam 14 on the workpiece 16a, 16b without moving the laser beam 14 along the machining path 18.

The movement of the laser beam 14 along the wobble pattern 19 may be achieved by deflecting the laser beam 14 along the wobble pattern 19 using the deflector 20 of FIG. 1, which is also used to move the laser beam 14 along the machining path 18. The movement along the wobble pattern 19 by the deflector 20 and the movement along the machining path 18 may also be performed by the previously described relative movement of the laser machining head 12 and the at least one workpiece 16a, 16b with respect to one another.

Alternatively, the deflector 20 may comprise a first deflector for movement along the machining path 18 and a second deflector for movement along the wobble pattern 19. The first deflector may be configured as a large field scanner, for example, and the second deflector may be configured as a small field scanner. The movement along the wobble pattern 19 by means of the second deflector and the movement along the machining path 18 may also be carried out by a combination of the above-described relative movement of the laser machining head 12 and the at least one workpiece 16a, 16b with respect to one another and the deflection by means of the first deflector.

The wobble motion and wobble pattern are illustrated with reference to FIG. 5. Assuming that the laser beam 14 is moved at a predetermined machining velocity, which is represented by the machining velocity vector 38, along the machining path 18, but without a wobbling movement along the wobble pattern 19 on the workpiece 16a, this movement of the laser beam 14 can be associated with a position 40 on the machining path 18. This position on the machining path 18 may also be referred to as a (theoretical) machining point 40. This machining point 40 therefore moves at the machining velocity along the machining path 18 and may be used as the origin of a two-dimensional Cartesian coordinate system x′-y′ parallel to the surface of the workpiece 16a, with an x′-axis of this coordinate system extending in parallel to the machining velocity vector 38 and a y′-axis perpendicular thereto. The wobble FIG. 19 may then be regarded as a stationary figure in this coordinate system. The x′-y′ coordinate system thus moves with the machining velocity and the machining velocity vector 38 along the machining path 18 over the workpiece 16a.

The wobble pattern shown in FIG. 5 is circular with the center of the circle coinciding with the origin of the x′-y′ coordinate system. A start and an end point of the wobble pattern 19 thus coincide. However, the present disclosure is not limited thereto. The wobble pattern 19 may also be arranged asymmetrically to the x′ and/or y′ axis and/or a center point of the wobble pattern 19 may be spaced from the origin of the coordinate system.

According to alternative embodiments, the wobble pattern 19 may be formed as a line that is formed along the y′-axis, and thus transversely to the machining path 18, or along the x′-axis, and thus along the machining path 18 or in parallel to the machining velocity vector 38. The wobble pattern 19 may also have the shape of a figure eight or a peanut shape.

According to the embodiment shown in FIG. 5, the laser beam 14 is repeatedly moved along the wobble pattern 19 while moving along the machining path 18. In other words, the laser beam circles the machining point 40. This results in a periodic or oscillating movement of the position of the laser beam 14 in at least one of the corresponding coordinate axes x, y or x′, y′ in the x′-y′ coordinate system or in the x-y coordinate system over time, respectively. Accordingly, the wobble movement may be viewed as an oscillating deflection or movement of the laser beam 14 relative to or superimposed with the movement along the machining path 18. The movement along the wobble pattern 19 usually takes place at a significantly higher speed than the movement along the machining path 18 so that a high-frequency oscillating movement of the laser beam 14 results, which is superimposed with the movement along the machining path 18.

The position of the laser beam 14 on the workpiece 16a may correspond to or be associated with a position of the laser beam 14 in the wobble pattern 19. According to the embodiment shown in FIG. 5, the laser power of the core beam and/or the laser power of the ring beam is adjusted when the laser beam 14 is moved along the wobble pattern 19. Accordingly, the laser power of the core beam and/or the laser power of the ring beam is adjusted as a function of a position of the laser beam 14 on the wobble pattern 19. The laser powers may be adjusted at the position of the laser beam 14 based on the properties of the workpiece 16a mentioned with reference to FIG. 2, in particular the thickness, the thermal conductivity and/or the material of the workpiece 16a. The adjustment may be performed as an alternative or in addition to the adjustment when moving the laser beam 14 along the machining path 18.

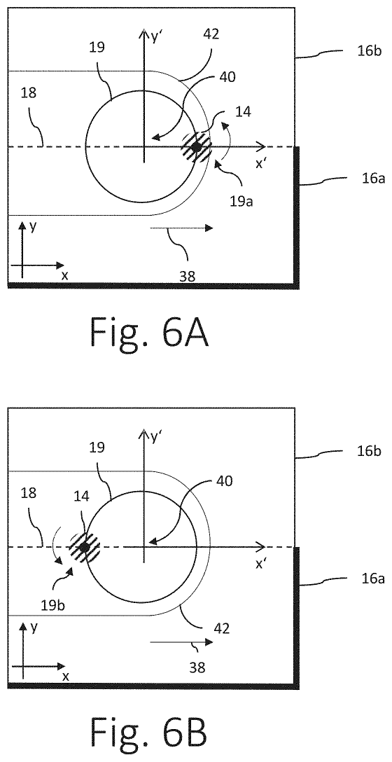

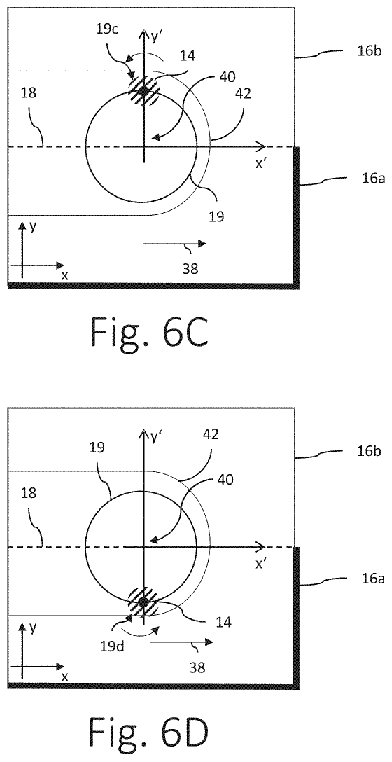

FIGS. 6A-6D show top views of workpieces illustrating a method of laser machining according to embodiments of the present disclosure.

FIGS. 6A-6D shows an embodiment in which the workpieces 16a, 16b are arranged in a butt joint and are to be welded by a weld seam at the abutting edge of the workpieces 16a, 16b so that the specified machining path 18 also extends along the abutting edge of the workpieces 16a, 16b. The laser beam 14 is therefore radiated both onto the workpiece 16a and onto the workpiece 16b.

The already partially formed weld seam 42 is also shown schematically in FIGS. 6A-6D. The movement of the laser beam along the machining path 18 is superimposed with a wobble movement along the circular wobble pattern 19. The wobble pattern 19 comprises four positions 19a, 19c, 19b and 19d through which the laser beam 14 passes in this order.

Here, the workpiece 16a is thicker, for example approximately 50% thicker, than the workpiece 16b, i.e. the workpiece 16a has a thickness of 150% of the thickness of workpiece 16b.

According to the embodiment shown in FIGS. 6A-6D, the laser power of the core beam 5 and/or the laser power of the ring beam is adjusted when the laser beam 14 is moved along the wobble pattern 19. Accordingly, the laser power of the core beam and/or the laser power of the ring beam is adjusted as a function of a position of the laser beam 14 on the wobble pattern 19. The laser powers may be adapted to the position of the laser beam 14 based on the properties of the workpiece 16a mentioned with reference to FIG. 2, in particular the thickness, the thermal conductivity and/or the material of the workpieces 16a, 16b. The adjustment may be performed as an alternative or in addition to the adjustment when moving the laser beam 14 along the machining path 18.

In FIG. 6A, the laser beam 14 is at a first position 19a of the wobble pattern 19 in advance on the machining path 18. The first position 19a corresponds to an intersection of the wobble pattern 19 with the machining path 18 when following the machining path 18 from the machining point 40 in the machining direction. The first position 19a is arranged in an area of the workpieces 16a, 16b which has not previously been machined, i.e. onto which the laser beam 14 has not previously been radiated.

In FIG. 6B, the laser beam 14 is at a second position 19b of the wobble pattern 19 in the wake on the machining path 18. The second position 19b corresponds to an intersection of the wobble pattern 19 with the machining path 18 when following the machining path 18, starting from the machining point 40, in the opposite direction to the machining direction.

The second position 19b is arranged in an area of the workpieces 16a, 16b which has previously been machined, i.e. onto which the laser beam 14 has already been radiated. During this, the material of the workpieces 16a, 16b was melted and solidified again as it cooled, as a result of which the weld seam 42 was formed. As a rule, the material in this area has changed; in particular, the thermal conductivity of the changed material at the second position 19b in the wake may be lower than the thermal conductivity in the first position 19a in advance. The laser beam 14 is guided over the weld seam 42 again by moving along the wobble pattern 19.

According to embodiments, the laser power of the core beam at the first position 19a in advance is set to be greater than the laser power of the core beam at the second position 19b in the wake. For example, the laser power of the core beam at the first position 19a in advance is set to 100% with respect to the maximum laser power of the core beam, and at the second position 19b in the wake is set to be equal to or less than 50%, for example 30%, with respect to the maximum laser power of the core beam. The laser power of the ring beam at the first position 19a in the forward direction is set, for example, to 100% with respect to the maximum laser power of the ring beam, and at the second position 19b in the wake is set to be equal to or less than 50%, for example 30%, with respect to the maximum laser power of the ring beam.

The wobble pattern 19 may also include at least one lateral position to the side of the machining path 19. As shown in FIGS. 6C and 6D, the wobble pattern 19 includes a first lateral position 19c on a left side of the machining path 18 with respect to the machining direction 38 and a second lateral position 19d on a right side of the machining path 18 with respect to the machining direction 38. Here, the first lateral position 19c is arranged on the thinner workpiece 16b and the second lateral position 19d is arranged on the thicker workpiece 16a. The lateral positions 19c, 19d are therefore arranged at a distance from the machining path 18. As shown in FIGS. 6C and 6D, the lateral positions 19c, 19d on the wobble pattern 19 correspond to an intersection of the wobble pattern 19 with the coordinate axis y′, i.e. with a line extending perpendicular to the machining path 18 through the machining point 40.

According to embodiments, the laser power of the core beam at the lateral positions 19c, 19d is set to be smaller than the laser power of the core beam at the first position 19a in advance and/or at the second position 19b in the wake. Accordingly, the laser power of the ring beam at the lateral positions 19c, 19d is set to be smaller than the laser power of the ring beam at the first position 19a in advance and/or in the second position 19b in the wake.

According to embodiments, the laser power of the core beam and the laser power of the ring beam are set as a function of a thickness of the workpieces 16a, 16b at the position of the laser beam 14. The thickness has an influence on the thermal conductivity of the workpiece 30 16a, 16b at the position of the laser beam 14. The laser power of the core beam and/or the laser power of the ring beam may, for example, be set in proportion to the thickness of the workpiece 16a, 16b at the position of the laser beam 14.

According to further embodiments that are not shown, the workpieces 16a, 16b are of the same thickness, but are made of different materials. For example, the workpiece 16a consists of a material with a higher thermal conductivity than the material of the workpiece 16b. For example, the workpiece 16a is made of copper or a copper alloy and the workpiece 16b is made of aluminum or an aluminum alloy.

In this case, the laser power of the core beam and/or the laser power of the ring beam may be adjusted as a function of the material or a specific thermal conductivity of the material of the workpieces 16a, 16b at the position of the laser beam 14. The specific thermal conductivity influences the absolute thermal conductivity of the workpiece 16a, 16b at the position of the laser beam 14. The laser power of the core beam and/or the laser power of the ring beam may, for example, each be set in proportion to the specific thermal conductivity of the workpiece 16a, 16b at the position of the laser beam 14.

In other words, the laser power of the core beam and/or the laser power of the ring beam may be set to be greater with an increasing thickness and/or specific thermal conductivity of the workpiece at the position of the laser beam 14. In the first case, the laser power of the ring beam and the laser power of the core beam at the position 19c on the workpiece 16b with the smaller thickness are respectively set to be smaller than at the position 19c on the workpiece 16a with the larger thickness. In the second case, the laser power of the ring beam and the laser power of the core beam at the position 19c on the workpiece 16b made of aluminum are each set to be smaller than at the position 19c on the workpiece 16a made of copper because copper has a higher specific thermal conductivity than aluminum.

For example, the laser power of the ring beam and the laser power of the core beam at the position 19c on the workpiece 16b are each set to be smaller than at the position 19d on the workpiece 16a. The laser power of the core beam may be set to 30% with respect to the maximum laser power of the core beam at the first lateral position 19c and to 50% with respect to the maximum laser power of the core beam at the second lateral position 19d. The laser power of the ring beam may be set to 40% with respect to the maximum laser power of the ring beam at the first lateral position 19c and to 50% with respect to the maximum laser power of the ring beam at the second lateral position 19d.

Alternatively or additionally, a difference between the relative laser power of the ring beam and the laser power of the core beam may be adjusted in inverse proportion to a thickness and/or specific thermal conductivity of the workpieces 16a, 16b at the position of the laser beam 14. In other words, the difference between the relative laser power of the ring beam and the relative laser power of the core beam may be set to be smaller with an increasing thickness and/or specific thermal conductivity of the workpieces 16a, 16b at the position of the laser beam 14. A relative laser power indicates the set laser power with respect to the maximum laser power. For example, the difference between the relative laser power of the ring beam and the relative laser power of the core beam is 10% at the first lateral position 19c and the difference is zero at the second lateral position 19d. As a result, the effect that, as the thickness decreases or as the specific thermal conductivity decreases, more power relative to the laser power radiated onto the workpiece 16a or 16b by the core beam is dissipated in the radial direction on the workpiece 16a, 16b is taken into account. As a result, the material may not heat up sufficiently or as anticipated in order to melt or vaporize. As a result, the laser welding process may not be carried out properly. By increasing the difference between the relative laser power of the core beam and the relative laser power of the ring beam, the radially dissipated power may be compensated for by the additional laser power of the ring beam. As a result, machining errors in the laser welding process can be prevented.

The invention includes a method and a laser machining system for laser machining, in particular for laser welding, workpieces using a laser beam with a core beam and a ring beam extending coaxially, wherein the laser power of the core beam and the laser power of the ring beam are adjusted independently of one another during the laser machining process, for example the laser welding process, or modulated or adjusted as a function of the position of the laser beam on the workpiece or in the scan field in order to obtain an optimal machining result, in particular an optimal welding result. This results in particular advantages when welding workpieces made of high-strength steel, aluminum and copper, or when welding materials with significantly different thermal conductivities. For example, hot cracks and spatter are reduced or prevented.

1. A method of laser machining a workpiece, said method comprising the steps of:
radiating a laser beam onto at least one workpiece, said laser beam including a core beam and a ring beam which extend coaxially with one another, wherein said laser beam is moved along a predetermined machining path over said workpiece;
adjusting a laser power of said core beam and/or a laser power of said ring beam as a function of a position of said laser beam on said workpiece.

2. The method according to claim 1, wherein adjusting the laser power of said core beam and/or the laser power of said ring beam is carried out continuously or stepwise.

3. The method according to claim 1, wherein:
the position of said laser beam on said at least one workpiece corresponds to a position on said machining path; and
the laser power of said core beam and/or the laser power of said ring beam are adjusted along said predetermined machining path.

4. The method according to claim 3, wherein adjusting the laser power of said core beam and/or the laser power of said ring beam is carried out repeatedly and/or periodically along said machining path.

5. The method according to claim 1, further comprising:
while moving said laser beam along said machining path, moving said laser beam along a predetermined wobble pattern on said at least one workpiece;
wherein the position of said laser beam on said at least one workpiece corresponds to a position of said laser beam in said wobble pattern.

6. The method according to claim 5, wherein:
said wobble pattern comprises a first position in advance on said machining path and a second position in a wake on said machining path; and
the laser power of said core beam and the laser power of said ring beam at said first position are adjusted to be correspondingly greater than the laser power of said core beam and the laser power of said ring beam at said second position.

7. The method according to claim 6, wherein:
the wobble pattern comprises at least one lateral position to a side of said machining path; and
the laser power of said core beam and the laser power of said ring beam at the at least one lateral position are adjusted to be correspondingly smaller than the laser power of said core beam and the laser power of said ring beam at said first position in advance and/or the laser power of said core beam and the laser power of said ring beam at the at least one lateral position are each adjusted to be greater than the laser power of said core beam and the laser power of said ring beam at said second position in the wake.

8. The method according to claim 1, wherein the laser power of said core beam and/or the laser power of said ring beam are adjusted based on a material, a thermal conductivity and/or thickness of the at least one workpiece at the position of said laser beam on said workpiece.

9. The method according to claim 8, wherein:
the laser power of said core beam and/or the laser power of said ring beam are adjusted as a function of a thermal conductivity and/or a thickness of said at least one workpiece at the position of said laser beam on said at least one workpiece; and/or
a difference between a relative laser power of said core beam and the relative laser power of said ring beam is adjusted as a function of a thermal conductivity and/or a thickness of said at least one workpiece at the position of said laser beam.

10. The method according to claim 8, wherein:
the at least one workpiece comprises two workpieces;
the predetermined machining path extends along an abutting edge of the two workpieces, wherein the laser power of said core beam and/or the laser power of said ring beam are adjusted as a function of a thickness of at least one of said workpieces along said machining path; and/or
wherein a difference between the relative laser power of said ring beam and the relative laser power of said core beam is adjusted as a function of a thickness of at least one of said workpieces along said machining path.

11. The method according to claim 1, wherein the laser power of said core beam and the laser power of said ring beam are adjusted independently of one another.

12. The method according to claim 1, wherein:
a quotient of the laser power of said core beam and the laser power of said ring beam during the movement of said laser beam along said machining path and/or along a wobble pattern is constant; or
a sum of the laser power of said core beam and the laser power of said ring beam is constant during the movement of said laser beam along said machining path and/or along said wobble pattern.

13. The method according to claim 1, wherein said core beam and said ring beam have different wavelengths.

14. A laser machining system for laser machining a workpiece, comprising:
a laser machining head for radiating a laser beam with a core beam and a ring beam extending coaxially with said core beam onto at least one workpiece; and
a control unit configured to carry out a method according to claim 1.

15. The laser machining system according to claim 14, further comprising:
at least one laser source for providing said core beam and said ring beam; and
an optical fiber configured to guide said core beam and said ring beam from said at least one laser source to said laser machining head.
